(19) United States
(12) Patent Application Publication
(10) Pub. No.: US 2010/0315378 A1
(43) Pub. Date: Dec. 16, 2010

(54) PLASMA DISPLAY AND DRIVING METHOD THEREOF

(76) Inventors: Tae-Yong Song, Suwon-si (KR); Suk-Jae Park, Suwon-si (KR); Woo-Joon Chung, Suwon-si (KR)

Correspondence Address: CHRISTIE, PARKER & HALE, LLP, PO BOX 7068, PASADENA, CA, 91109-7068, US

(21) Appl. No.: 12/691,658

(22) Filed: Jan. 21, 2010

Related U.S. Application Data
(60) Provisional application No. 61/186,373, filed on Jun. 11, 2009.

(51) Int. Cl. G06F 3/042; G09G 5/00; G09G 3/28

(52) U.S. Cl. 345/175; 345/211; 345/60

(57) ABSTRACT

A plasma display device with touch sensing function includes a display panel having a plurality of first and second electrodes, and third electrodes crossing the first and second electrodes, and first, second and third drivers adapted to drive the first, second and third electrodes in a plurality of subfields including a sensing subfield having a first period and a second period. During the first period, the first driver is adapted to apply a first voltage higher than a reference voltage to the first electrodes, the second driver is adapted to time sequentially apply a second voltage lower than the first voltage to the second electrodes. During the second period, the first driver is adapted to apply a fourth voltage lower than the first voltage to the first electrodes, and the third driver is adapted to time sequentially apply a third voltage higher than the reference voltage to the third electrodes.

### BACKGROUND OF THE INVENTION

(a) Field of the Invention

The present invention relates to a plasma display and a method of driving the same. More particularly, the present invention relates to a plasma display having a touch sensing function and a driving method thereof.

(b) Description of the Related Art

A plasma display device is a display device with a plasma display panel that displays characters or images using plasma generated by a gas discharge.

One frame (or field) is divided into a plurality of subfields so as to drive the plasma display device and display an image. Each subfield has a luminance weight value, and includes an address period and a sustain period. The plasma display device selects cells to be turned on (hereinafter, turn-on cells) and cells to be turned off (hereinafter, turn-off cells) during an address period, and performs sustain discharges on the turn-on cells a number of times corresponding to a luminance weight value of the corresponding subfield to display an image during a sustain period.

The above described plasma display device can be equipped to sense a user's touch and process it. To implement such a touch sensing function, an infrared source may be added to the inside of the plasma display, and an external sensor may sense infrared light emitted from the infrared source. However, this leads to a problem that the infrared source has to be additionally mounted on the plasma display.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Aspects of embodiments of the present invention are directed toward a plasma display capable of implementing a touch sensing function and a driving method thereof.

According to an exemplary embodiment of the present invention, there is provided a plasma display device including: a display panel including a plurality of first electrodes and a plurality of second electrodes extending in pairs along a first direction and a plurality of third electrodes extending in a second direction crossing the first direction; and a first driver coupled to the first electrodes, a second driver coupled to the second electrodes and a third driver coupled to the third electrodes, the first, second and third drivers being adapted to drive the display panel in a plurality of subfields including a sensing subfield having a first period and a second period. During the first period, the first driver is adapted to apply a first voltage higher than a reference voltage to the first electrodes, the second driver is adapted to time sequentially apply a second voltage lower than the first voltage to the second electrodes. During the second period, the first driver is adapted to apply a fourth voltage lower than the first voltage to the first electrodes, and the third driver is adapted to time sequentially apply a third voltage higher than the reference voltage to the third electrodes.

According to another embodiment of the present invention, there is provided a driving method of a plasma display device with a display panel including a plurality of first electrodes and a plurality of second electrodes extending in pairs along a first direction and a plurality of third electrodes extending in a second direction crossing the first direction, the display panel driven in a plurality of subfields including a sensing subfield having a first period and a second period. The method includes: during the first period, applying a first voltage higher than a reference voltage to the first electrodes and applying time sequentially a second voltage lower than the first voltage to the second electrodes; and during the second period, applying a fourth voltage lower than the first voltage to the first electrodes and applying time sequentially a third voltage higher than the reference voltage to the third electrodes.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram of a plasma display according to one exemplary embodiment of the present invention.

FIG. 2 is a table showing an arrangement of subfields according to the exemplary embodiment of the present invention.

FIG. 3 is a schematic drawing showing driving waveforms in an image display subfield of a plasma display device according to one exemplary embodiment of the present invention.

FIG. 4 is a schematic drawing showing driving waveforms in a sensing subfield of a plasma display device according to one exemplary embodiment of the present invention.

FIG. 5 and FIG. 6 are schematic drawings respectively showing driving waveforms in a sensing subfield of a plasma display device according to one exemplary embodiment of the present invention.

FIG. 7 and FIG. 8 are schematic drawings respectively showing driving waveforms in a sensing subfield of a plasma display device according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

Henceforth, a plasma display and a driving method thereof according to an exemplary embodiment of the present invention will be described in detail with reference to the accompanying drawings.

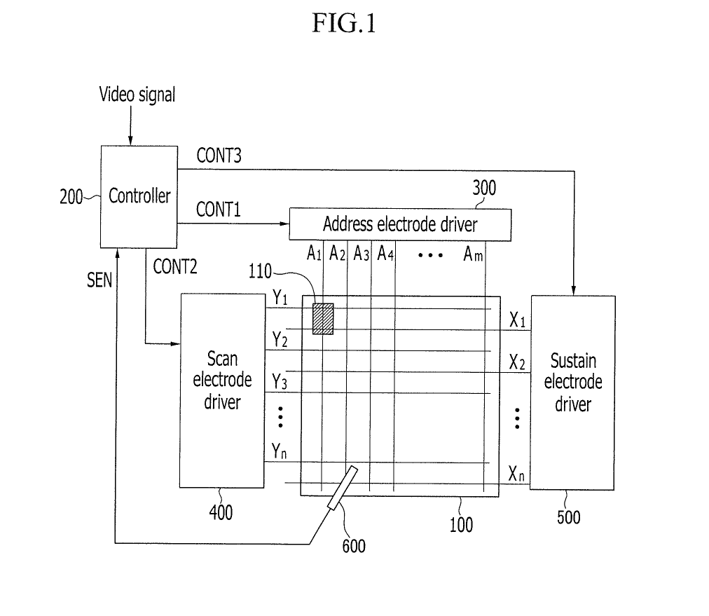

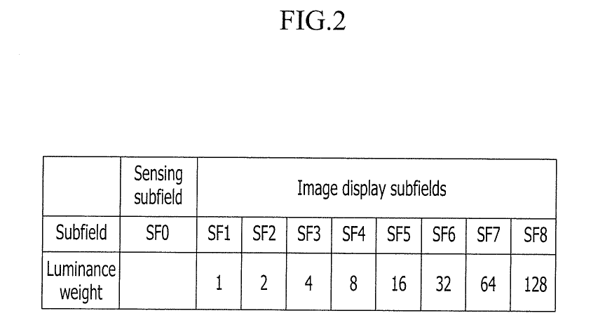

FIG. 1 is a schematic block diagram of a plasma display according to one exemplary embodiment of the present invention, and FIG. 2 is a table showing an arrangement of subfields according to the exemplary embodiment of the present invention.

Referring to FIG. 1, the plasma display device includes a plasma display panel (PDP) 100, a controller 200, an address electrode driver 300, a scan electrode driver 400, a sustain electrode driver 500, and an optical sensor 600.

The plasma display panel (PDP) 100 includes a plurality of display electrodes Y1-Yn and X1-Xn, a plurality of address electrodes (hereinafter, “A electrodes”) A1-Am, and a plurality of discharge cells 110.

The plurality of display electrodes Y1-Yn and X1-Xn includes a plurality of scan electrodes (hereinafter, “Y electrodes”) Y1-Yn and a plurality of sustain electrodes (hereinafter, “X electrodes”) X1-Xn. The Y electrodes Y1-Yn and X electrodes X1-Xn extend substantially in a row direction (i.e., X-axis direction) and are substantially parallel with each other, and the A electrodes A1-Am extend substantially in a column direction (i.e., Y-axis direction) and are substantially parallel with each other. The Y electrodes Y1-Yn may correspond to the X electrodes X1-Xn, one to one. Alternatively, two X electrodes X1-Xn may correspond to one Y electrode Y1-Yn, or two Y electrodes Y1-Yn may correspond to one X electrode X1-Xn. Discharge spaces defined by the A electrodes A1-Am and the X and Y electrodes X1-Xn and Y1-Yn form the discharge cells 110.

The structure of the above described plasma display panel 100 shows one example, and a plasma display panel 100 with a different structure can be also applicable according to an exemplary embodiment of the present invention.

The optical sensor 600 is wirelessly or wiredly connected to the controller 200, and transmits a sensing signal SEN (e.g., a light detecting information) to the controller 200 if it senses light generated from the plasma display panel. This optical sensor 600 includes a light receiving element for sensing light, and the light receiving element may be a photodiode, a phototransistor, etc. An external computer may receive and process the sensing signal SEN from the optical sensor 600, and then transmit the sensing signal to the controller 200.

The controller 200 receives a video signal and the sensing signal SEN. The video signal contains luminance information of each discharge cell 110, and the luminance of each discharge cell 110 may be expressed as one of a number (or a predetermined number) of gray levels.

The controller 200 divides one frame (or field) into a plurality of subfields SF0-SF8. Referring to FIG. 2, one of the plurality of subfield SF0-SF8, for example, the first subfield SF0, is a subfield for sensing (e.g., touch sensing), and the other subfields SF1-SF8 are subfields for displaying images. The plurality of image display subfields SF1-SF8 have respective luminance weight values. FIG. 2 illustrates that the image display subfields include eight subfields SF1-SF8 having luminance weights of 1, 2, 4, 8, 16, 32, 64, and 128, respectively, representing gray levels of 0 to 255.

The controller 200 processes the sensing signal SEN during a period corresponding to the sensing subfield and detects the position, i.e., coordinates, of the discharge cell 110 at which the optical sensor 600 senses light on the plasma display panel 100.

The controller 200 generates an A electrode driving control signal CONT1, a Y electrode driving control signal CONT2, and an X electrode driving control signal CONT3 by processing the video signal in accordance with the plurality of image display subfields SF1-SF8. In addition, the controller 200 generates the A electrode driving control signal CONT1, the Y electrode driving control signal CONT2, and the X electrode driving control signal CONT3 which are for touch sensing in the sensing subfield SF0. The controller 200 outputs the A electrode driving control signal CONT1 to the address electrode driver 300, outputs the Y electrode driving control signal CONT2 to the scan electrode driver 400, and outputs the X electrode driving control signal CONT3 to the sustain electrode driver 500.

In the plurality of subfields SF0-SF8, the address electrode driver 300 applies a driving voltage to the A electrodes A1-Am according to the A electrode driving control signal CONT1, the scan electrode driver 400 applies a driving voltage to the Y electrodes Y1-Yn according to the Y electrode driving control signal CONT2, and the sustain electrode driver 500 applies a driving voltage to the X electrodes X1-Xn according to the X electrode driving control signal CONT3.

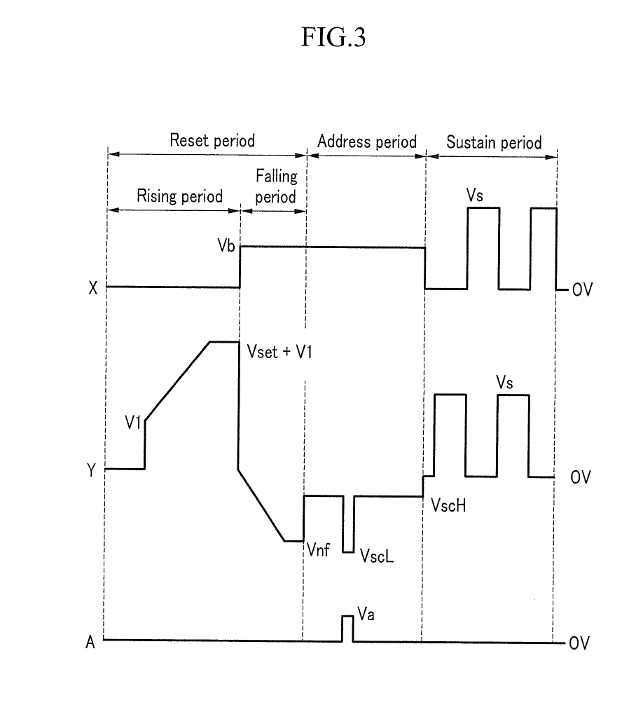

FIG. 3 is a drawing schematically showing driving waveforms in an image display subfield of a plasma display device according to one exemplary embodiment of the present invention.

In FIG. 3, for convenience of description, only one subfield SF1 of the plurality of image display subfields is described, and only driving waveforms applied to the A electrode, the X electrode, and the Y electrode forming one discharge cell is described.

Referring to FIG. 3, during a rising period of a reset period, the scan electrode driver 400 gradually increases a voltage of the Y electrode from a V1 voltage to a Vset+V1 voltage while the address electrode driver 300 and the sustain electrode driver 500 apply a predetermined voltage (for example, ground voltage in FIG. 3) to the A electrode and the X electrode. For example, the scan electrode driver 400 may increase the voltage of the Y electrode in a ramp pattern. While the voltage of the Y electrode gradually increases, a weak discharge is generated between the Y electrode and the X electrode and between the Y electrode and the A electrode. Thus, a negative (−) charge may be formed on the Y electrode, and a positive (+) charge may be formed on the X and A electrodes. In this embodiment, the V1 voltage may be, for example, a voltage difference VscH−VscL between a VscH voltage and a VscL voltage that will be described in more detail below. In addition, a V2 voltage may be a sum of the V1 voltage and a Vs voltage that will be described in more detail below.

Next, during a falling period of the reset period, the scan electrode driver 400 gradually decreases the voltage of the Y electrode from the ground voltage to a Vnf voltage while the address electrode driver 300 and the sustain electrode driver 500 apply a ground voltage and a Vb voltage to the A electrode and the X electrode, respectively. For example, the scan electrode driver 400 may decrease the voltage of the Y electrode in a ramp pattern. While the voltage of the Y electrode gradually decreases, a weak discharge is generated between the Y electrode and the X electrode and between the Y electrode and the A electrode. Thus, the negative (−) charge formed on the Y electrode and the positive (+) charge formed on the X and A electrodes during the rising period may be erased. Accordingly, the discharge cells 110 may be initialized. In this embodiment, the Vnf voltage may be set to a voltage of negative polarity, and the Vb voltage may be set to a voltage of positive polarity. In addition, the voltage difference Vb−Vnf between the Vb voltage and the Vnf voltage is set to a value close to a discharge firing voltage between the Y electrode and the X electrode to set the initialized discharge cells as turn-off cells. Moreover, during the falling period, the voltage of the Y electrode may gradually decrease from a voltage different than the ground voltage.

During the rising period of the reset period, the voltage of the Y electrode may be first set higher than the voltage of the X and A electrodes and then the voltage of the Y electrode may be set lower than the voltage of the X and A electrodes to induce a reset discharge on all of the discharge cells 110 for initialization.

Next, in the address period, to identify or select turn-on cells and turn-off cells, the scan electrode driver 400 sequentially applies a scan pulse having a VscL voltage (scan voltage) to the plurality of scan electrodes (Y1-Yn of FIG. 1) while the sustain electrode driver 500 applies the Vb voltage to the X electrode. At the same time, the address electrode driver 300 applies address pulses having a Va voltage (address voltage) to the A electrode passing through a turn-on cell among the plurality of discharge cells formed by the Y electrode receiving the VscL voltage. Thereby, positive (+) wall charges are formed on the Y electrode, and negative (−) wall charges are formed on the A and X electrodes because an address discharge occurs in the discharge cell (i.e., turn-on cell) formed by the A electrode receiving the Va voltage and the Y electrode receiving the VscL voltage. In addition, the scan electrode driver 400 may apply a VscH voltage (non-scan voltage) higher than the VscL voltage to the Y electrode to which the VscL voltage is not applied, and the address electrode driver 300 may apply a ground voltage to the A electrode to which the Va voltage is not applied. In this embodiment, the VscL voltage may be a negative polarity voltage, and the Va voltage may be a positive polarity voltage. Moreover, in the address period, a voltage different from the Vb voltage may be applied to the X electrode.

During the sustain period, the scan electrode driver 400 and the sustain electrode driver 500 apply sustain discharge pulses alternately having a high-level voltage Vs and a low-level voltage (e.g., ground voltage) of opposite phases. That is, when the high-level voltage Vs is applied to the Y electrode while the low-level voltage is applied to the X electrode, a sustain discharge may occur in the turn-on cells due to the voltage difference between the high-level voltage Vs and the low-level voltage; and then when the low-level voltage is applied to the Y electrode and the high-level voltage Vs is applied to the X electrode, a sustain discharge may occur again in the turn-on cells due to the voltage difference between the high-level voltage Vs and the low-level voltage. The above described operation is repeated during the sustain period, so that a sustain discharge occurs a number of times corresponding to the luminance weight value of the corresponding subfield. In another embodiment, while the ground voltage is applied to one electrode (for example, X electrode) among the Y and X electrodes, a sustain discharge pulse alternately having the Vs voltage and a −Vs voltage may be applied to the other electrodes (for example, Y electrode).

Although FIG. 3 illustrates the image display subfield SF1 including a reset period, an address period, and a sustain period, some image display subfields may not include a reset period. In a subfield having no reset period, the address period may be performed without initializing a wall charge state of the previous subfield. Also, in some image display subfields, the reset period may not include a rising period. In a subfield having no rising period, only turn-on cells of the previous subfield may be initialized during the reset period.

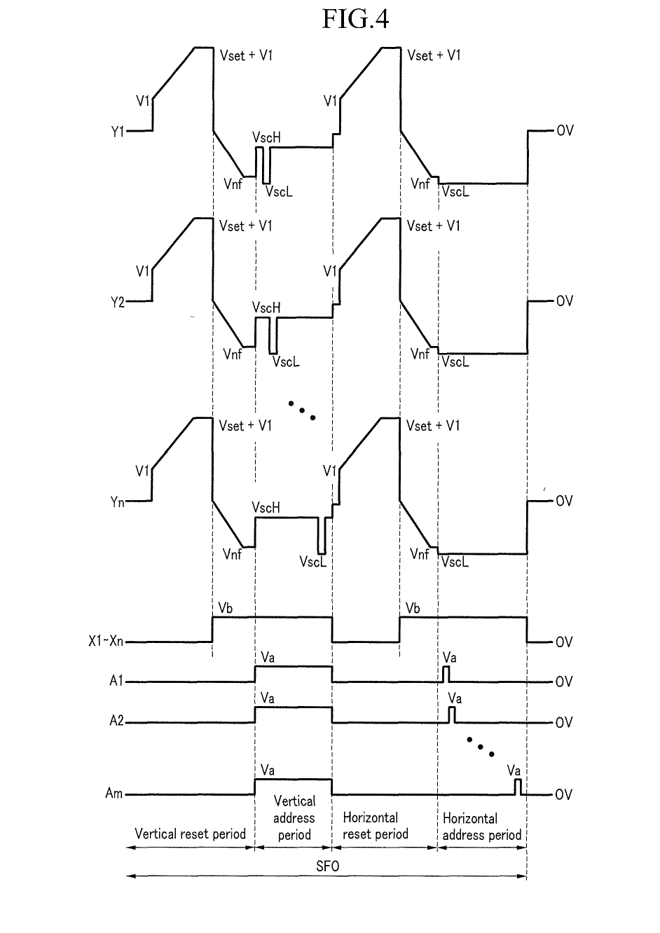

FIG. 4 is a drawing schematically showing driving waveforms in a sensing subfield of a plasma display device according to one exemplary embodiment of the present invention.

Referring to FIG. 4, the sensing subfield SF0 includes a vertical reset period, a vertical address period, a horizontal reset period, and a horizontal address period.

During the vertical reset period, the drivers 300, 400, and 500 apply reset waveforms to the A electrodes X1-Xm, Y electrodes Y1-Yn, and X electrodes X1-Xn to initialize the plurality of discharge cells 110. These reset waveforms may be the waveforms applied in the reset period of FIG. 3.

During the vertical address period, the scan electrode driver 400 sequentially applies a scan pulse having a VscL voltage to the plurality of Y electrodes Y1-Yn while the sustain electrode driver 500 applies a Vb voltage to the plurality of X electrodes X1-Xn and the address electrode driver 300 applies a Va voltage to the plurality of A electrodes A1-Am. A voltage (e.g., VscH voltage of FIG. 3) higher than the VscL voltage is applied to the Y electrodes to which the scan pulse is not applied. As described with reference to FIG. 3, an address discharge occurs between the A electrode and the Y electrode in the discharge cell formed by the A electrode receiving the Va voltage and the Y electrode receiving the VscL voltage. Thus, each time the VscL voltage is applied to each of the Y electrodes, an address discharge occurs in the plurality of discharge cells 110 formed by the corresponding Y electrode. That is, the position of a light-emitting discharge cell is changed in the Y-axis direction.

When a user makes the optical sensor 600 touch or approach the surface of the plasma display panel 100, the optical sensor 600 senses light generated from the discharge cell in the region touched (or approached) by the optical sensor 600 and transmits a sensing signal SEN to the controller 200. Then, the controller 200 can detect a position of the Y electrode of the discharge cell from which the optical sensor 600 detects the light by comparing a timing at which the scan pulse is applied to the plurality of Y electrodes Y1-Yn with a point in time at which the optical sensor 600 senses the light. That is, the controller 200 can detect the Y-axis direction position (Y coordinate) of the region touched or approached by the optical sensor 600 during the vertical address period.

Next, during the horizontal reset period, the drivers 300, 400, and 500 apply reset waveforms to the A electrodes A1-Am, Y electrodes Y1-Yn and X electrodes X1-Xn to re-initialize the plurality of discharge cells 110. Likewise, these reset waveforms may be the waveforms applied during the reset period of FIG. 3.

During the horizontal address period, the address electrode driver 300 sequentially applies an address pulse having a Va voltage to the plurality of A electrodes A1-Am while the scan electrode driver 400 applies a VscL voltage to the plurality of Y electrodes Y1-Yn and the sustain electrode driver 500 applies a Vb voltage to the plurality of X electrodes X1-Xn. Then, each time the Va voltage is applied to one of the A electrodes, an address discharge occurs between the A electrode applied with the Va voltage and the Y electrodes of the plurality of discharge cells 110 formed on the corresponding A electrode. That is, the position of a light-emitting discharge cell is changed in the X-axis direction.

Likewise, the optical sensor 600 senses light generated from the discharge cell of the region touched (or approached) by the optical sensor 600 and transmits a sensing signal SEN to the controller 200. Then the controller 200 can detect a position of the A electrode of the discharge cell from which the optical sensor 600 detects the light by comparing a timing at which the address pulse is applied to the plurality of A electrodes A1-Am with a point in time at which the optical sensor 600 senses the light. That is, the controller 200 can detect the X-axis direction position (x coordinate) of the region touched or approached by the optical sensor 600 during the horizontal address period.

Then, the controller 200 can detect the position (coordinates) of the region touched or approached by the optical sensor 600 based on the Y coordinate detected during the vertical address period and the X coordinate detected during the horizontal address period.

In FIG. 4, since the Vb voltage is applied to the X electrodes and the VscH voltage is applied to the Y electrodes before a discharge occurs during the vertical address period, a potential difference Exy1 between the X electrodes and the Y electrodes is given as in Equation 1 below. On the other hand, since the Vb voltage is applied to the X electrodes and the VscL voltage is applied to the Y electrodes before a discharge occurs during the horizontal address period, a potential difference Exy2 between the X electrodes and the Y electrodes is given as in Equation 2 below. Vwxy as shown below denotes a potential difference formed by the wall charge formed between the X electrodes and the Y electrodes. Also, a Vwxy voltage denotes a voltage value (potential difference formed by the wall charge) of the X electrodes which is measured with respect to the Y electrodes.

Exy1=Vb−VscH+Vwxy (Equation 1)

In Equation 1, Vwxy is a potential difference caused by the wall charge formed between the X electrodes and the Y electrodes at a time point of completion of the vertical reset period.

Exy2=Vb−VscL+Vwxy (Equation 2)

In Equation 2, Vwxy is a potential difference formed by the wall charge formed between the X electrodes and the Y electrodes at a time point of completion of the horizontal reset period.

Since the VscL voltage is lower than the VscH voltage, the potential difference Exy2 between the X electrodes and the Y electrodes during the horizontal address period is larger than the potential difference between the A electrodes and the Y electrodes during the vertical address period. Therefore, during the horizontal address period, a negative wall charge present on the Y electrodes may be lost due to the potential difference between the X electrodes and the Y electrodes. Here, the address discharge is generated between the A electrodes and the Y electrodes, and in this case, the A electrodes act as a cathode and the Y electrodes act as an anode. Thus, if the negative charge on the Y electrodes is lost, a weak address discharge may occur. Accordingly, light output becomes weaker during the horizontal address period, thus making it impossible or more difficult to accurately recognize the X coordinate.

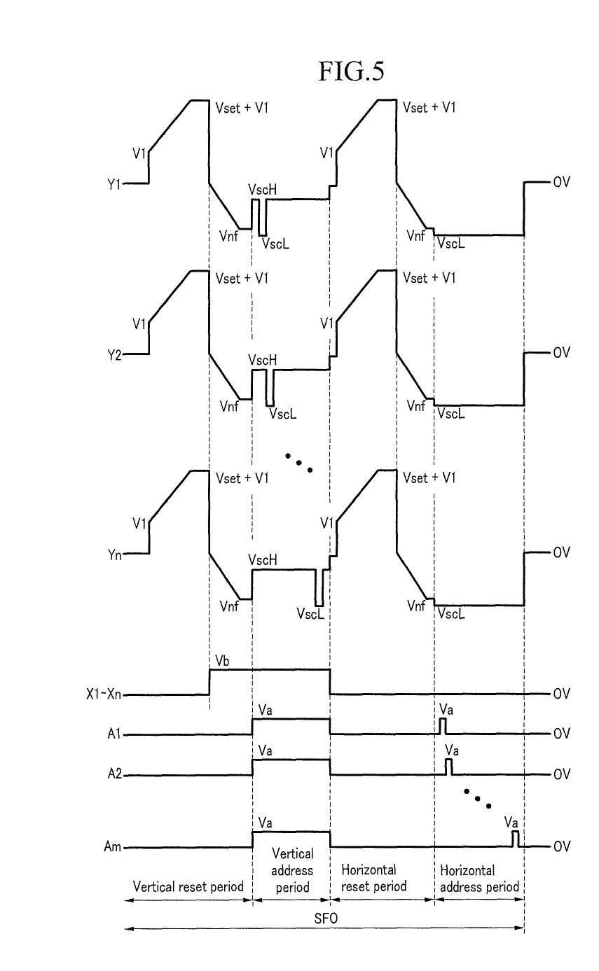

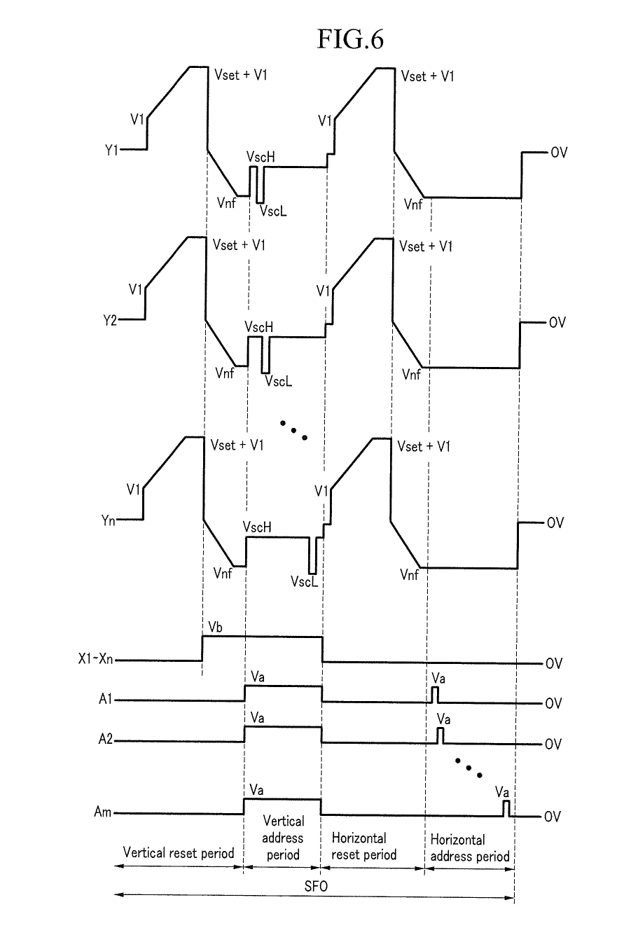

Hereinafter, an exemplary embodiment for increasing the intensity of light output in the horizontal address period will be described in more detail with reference to FIGS. 5 and 6.

FIG. 5 and FIG. 6 are schematic drawings respectively showing driving waveforms in a sensing subfield of a plasma display device according to one exemplary embodiment of the present invention.

Referring to FIG. 5, during the horizontal address period, the address electrode driver 300 sequentially applies an address pulse having a Va voltage to the plurality of A electrodes A1-Am, the scan electrode driver 400 applies a VscL voltage to the plurality of Y electrodes Y1-Yn, and the sustain electrode driver 500 applies a voltage lower than the Vb voltage to the plurality of X electrodes X1-Xn. Then, each time the Va voltage is applied to one of the A electrodes, an address discharge occurs in the plurality of discharge cells 110 formed by the corresponding A electrode.

Referring to FIG. 6, during the horizontal address period, the address electrode driver 300 sequentially applies an address pulse having a Va voltage to the plurality of A electrodes A1-Am, the scan electrode driver 400 applies a Vnf voltage to the plurality of Y electrodes Y1-Yn, and the sustain electrode driver 500 applies a voltage lower than the Vb voltage to the plurality of X electrodes X1-Xn. Then, each time the VA voltage is applied to one of the A electrodes, an address discharge occurs in the plurality of discharge cells 100 formed on the corresponding A electrode.

In FIG. 5 and FIG. 6, in order to eliminate an additional power supply for supplying a voltage lower than the Vb voltage, the voltage lower than the Vb voltage may be set to 0V.

In the embodiments of FIGS. 5 and 6, the potential difference Exy2 between the X electrodes and the Y electrodes during the horizontal address period becomes as shown in Equations 3 and 4 below, which is smaller than the potential difference Exy2 in Equation 2. Therefore, it is possible to increase the intensity of light output caused by the address discharge by preventing or reducing loss of a negative charge present on the Y electrodes.

Exy2=−VscL+Vwxy (Equation 3)

Equation 3 represents the potential difference between the X electrodes and the Y electrodes during the horizontal address period in FIG. 5.

Exy2=−Vnf+Vwxy (Equation 4)

Equation 4 represents the potential difference between the X electrodes and the Y electrodes in the horizontal address period in FIG. 6.

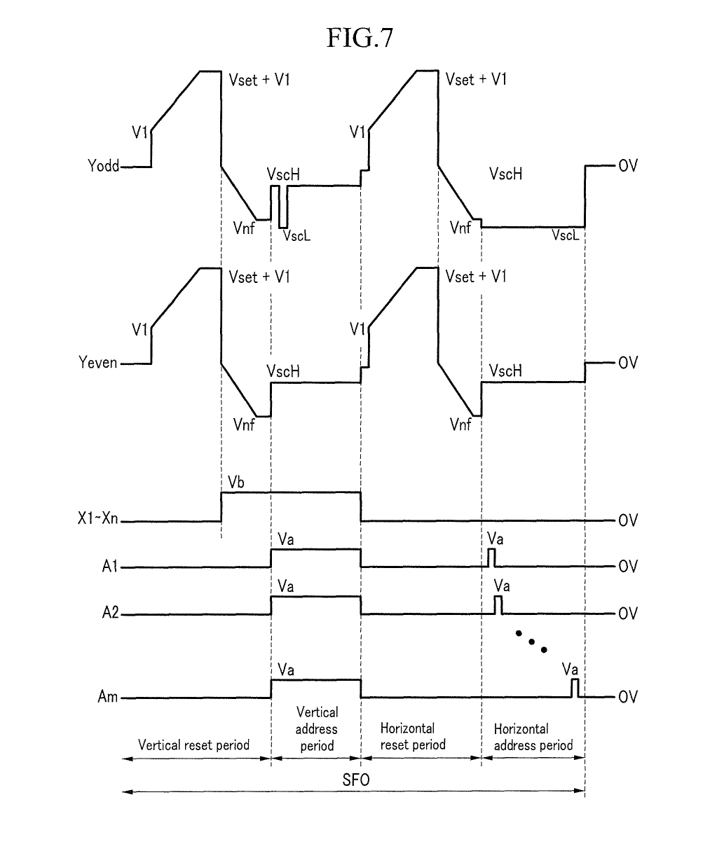

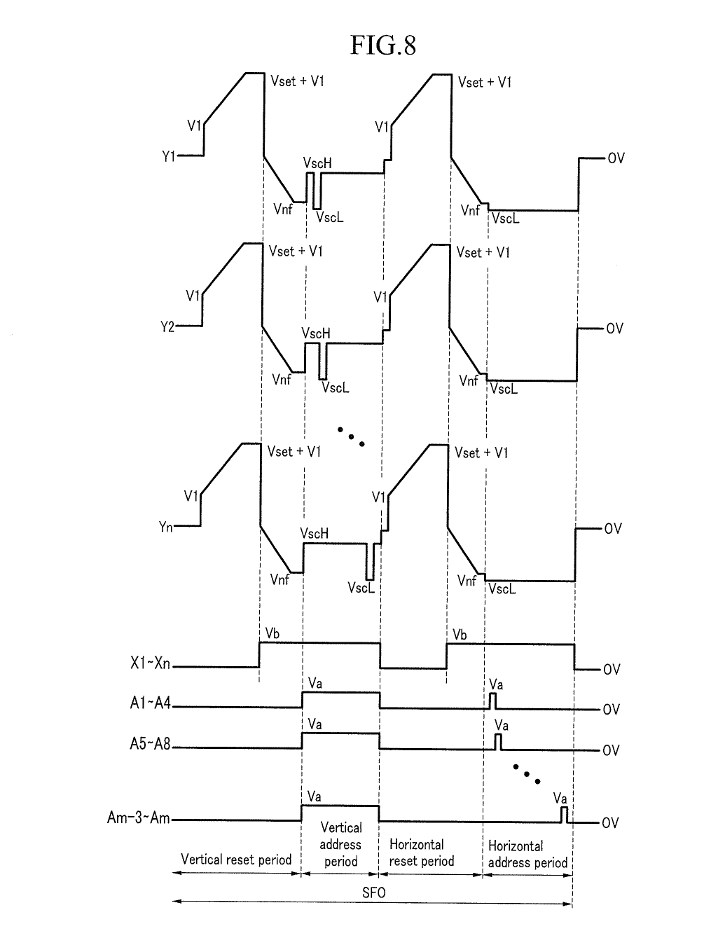

FIG. 7 and FIG. 8 are schematic drawings respectively showing driving waveforms in a sensing subfield of a plasma display device according to another exemplary embodiment of the present invention.

Referring to FIG. 7, the plurality of Y electrodes is divided into a plurality of groups, and a scan pulse is sequentially applied to the Y electrodes of one of the plurality of groups during the vertical address period. FIG. 7 illustrates that the plurality of Y electrodes is divided into an odd-numbered group composed of odd-numbered Y electrodes Y1, Y3, . . . and an even-numbered group composed of even-numbered Y electrodes Y2, Y4, . . . .

During the vertical address period, the scan electrode driver 400 sequentially applies a scan pulse having a VscL voltage to the Y electrodes Y1, Y3, . . . of the odd-numbered group while it applies a voltage (e.g., VscH voltage) higher than the VscL voltage to the Y electrodes Y2, Y4, . . . of the even-numbered group. Then, an address discharge sequentially occurs with the Y electrodes Y1, Y3, . . . of the odd-numbered group. By doing so, the length or duration of the vertical address period can be shortened.

In general, a touch area of the optical sensor is larger than the size of one discharge cell, and therefore generating an address discharge only with the Y electrodes Y1, Y3, . . . of the odd-numbered group is sufficient to detect a Y-axis position.

Referring to FIG. 8, the plurality of A electrodes A1-Am is divided into a plurality of groups, and an address pulse is sequentially applied to the A electrodes of one of the plurality of groups. FIG. 8 illustrates that the plurality of A electrodes are divided into four groups.

For example, the address electrode driver 300 can sequentially apply an address pulse to the A electrodes A1, A5, . . . , Am-3 of the first group during the horizontal address period. Then, an address discharge occurs at the A electrodes A1, A5, . . . , Am-3 of the first group. By doing so, the length of the horizontal address period can be shortened.

While an address pulse is being applied to the A electrodes A1, A5, . . . , Am-3 of the first group, the address electrode driver 300 may apply an address pulse to the A electrodes of other groups at the same timing. That is, an address pulse is applied to the A electrodes A1-A4 of the first one of the four groups at the same timing, and then an address pulse is applied to the A electrodes A5-A8 of the second one of the four groups.

In another embodiment of the present invention, while an address pulse is being applied to the A electrodes A1, A5, . . . , Am-3 of the first group, the address electrode driver 300 may apply a voltage of 0V without applying an address pulse to the A electrodes of other groups.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and equivalents thereof.

What is claimed is:

1. A plasma display device comprising:
a display panel comprising a plurality of first electrodes and a plurality of second electrodes extending in pairs along a first direction and a plurality of third electrodes extending in a second direction crossing the first direction; and
a first driver coupled to the first electrodes, a second driver coupled to the second electrodes and a third driver coupled to the third electrodes, the first, second and third drivers being adapted to drive the display panel in a plurality of subfields comprising a sensing subfield having a first period and a second period,
wherein, during the first period, the first driver is adapted to apply a first voltage higher than a reference voltage to the first electrodes, the second driver is adapted to time sequentially apply a second voltage lower than the first voltage to the second electrodes, and
wherein, during the second period, the first driver is adapted to apply a fourth voltage lower than the first voltage to the first electrodes, and the third driver is adapted to time sequentially apply a third voltage higher than the reference voltage to the third electrodes.

2. The plasma display device of claim 1, further comprising a controller adapted to receive a light detecting information from an external device to determine a position of the external device relative to the display panel.

3. The plasma display device of claim 2, wherein the controller is adapted to determine the position of the external device by comparing a timing at which the controller receives the light detecting information and timings at which the second and third voltages are applied during the first and second periods, respectively.

4. The plasma display device of claim 2, wherein the external device is an optical sensor.

5. The plasma display device of claim 2, wherein the controller is adapted to determine a corresponding second electrode of a discharge cell from which light has been emitted, from among the second electrodes, by comparing a timing at which the second voltage is applied to the corresponding second electrode with a timing at which the light is detected during the first period.

6. The plasma display device of claim 2, wherein the controller is adapted to determine a corresponding third electrode of a discharge cell from which light has been emitted, from among the third electrodes, by comparing a timing at which the third voltage is applied to the corresponding third electrode with a timing at which the light is detected during the second period.

7. The plasma display device of claim 1, wherein, during the first period, while the first voltage is being applied to the first electrodes and the second voltage is being time sequentially applied to the second electrodes, the third driver is adapted to apply the third voltage to the third electrodes.

8. The plasma display device of claim 1, wherein, during the second period, while the fourth voltage is being applied to the first electrodes and the third voltage is being time sequentially applied to the third electrodes, the second driver is adapted to apply a fifth voltage to the second electrodes.

9. The plasma display device of claim 8, wherein the fifth voltage is substantially identical to the second voltage.

10. The plasma display device of claim 1, wherein adjacent ones of the second electrodes are divided into at least two different groups, and the second driver is adapted to apply time sequentially the second voltage to the second electrodes of one of the at least two different groups during the first period.

11. The plasma display device of claim 1, wherein adjacent ones of the third electrodes are divided into at least two different groups, and the third driver is adapted to apply time sequentially the third voltage to the third electrodes of one of the at least two different groups during the second period.

12. The plasma display device of claim 1, wherein the first period is a vertical address period and the second period is a horizontal address period.

13. A driving method of a plasma display device with a display panel comprising a plurality of first electrodes and a plurality of second electrodes extending in pairs along a first direction and a plurality of third electrodes extending in a second direction crossing the first direction, the display panel driven in a plurality of subfields comprising a sensing subfield having a first period and a second period, the method comprising:
during the first period, applying a first voltage higher than a reference voltage to the first electrodes and applying time sequentially a second voltage lower than the first voltage to the second electrodes; and
during the second period, applying a fourth voltage lower than the first voltage to the first electrodes and applying time sequentially a third voltage higher than the reference voltage to the third electrodes.

14. The method of claim 13, further comprising:
detecting light emitted from the display panel; and
determining a sensing position of the light relative to the display panel by comparing a timing at which the light from the display panel is detected and timings at which the second and third voltages are applied during the first and second periods, respectively.

15. The method of claim 14, wherein said determining of the sensing position of the light relative to the display panel comprises:
determining a corresponding second electrode of a discharge cell from which the light has been emitted, from among the second electrodes, by comparing a timing at which the second voltage is applied to the corresponding second electrode with a timing at which the light is detected during the first period.

16. The method of claim 14, wherein said determining of the sensing position of the light relative to the display panel comprises:
determining a corresponding third electrode of a discharge cell from which the light has been emitted, from among the third electrodes, by comparing a timing at which the third voltage is applied to the corresponding third electrode with a timing at which the light is detected during the second period.

17. The method of claim 13, further comprising:
during the first period, while applying the first voltage to the first electrodes and applying time sequentially the second voltage to the second electrodes,
applying the third voltage to the third electrodes.

18. The method of claim 13, further comprising:
during the second period, while applying the fourth voltage to the first electrodes and applying time sequentially the third voltage to the third electrodes,
applying a fifth voltage to the second electrodes.

19. The method of claim 18, wherein the fifth voltage is substantially identical to the second voltage.

20. The method of claim 13, wherein adjacent ones of the second electrodes are divided into at least two different groups and the second voltage is time sequentially applied to the second electrodes of the at least two different groups during the first period.

21. The method of claim 13, wherein adjacent ones of the third electrodes are divided into at least two different groups, and the third voltage is time sequentially applied to the third electrodes of one of the at least two different groups during the second period.

22. The method of claim 13, wherein the first period is a vertical address period and the second period is a horizontal address period.
